(19) United States
(12) Patent Application Publication
(10) Pub. No.: US 2016/0180104 A1
(43) Pub. Date: Jun. 23, 2016

(54) PATTERN DRIVEN DATA PRIVACY MANAGEMENT

(71) Applicant: SugarCRM Inc., Cupertino, CA (US)

(72) Inventor: Logain Asfour, Sunnyvale, CA (US)

(21) Appl. No.: 14/576,445

(22) Filed: Dec. 19, 2014

(51) Int. Cl. G06F 21/62

(52) U.S. Cl. CPC G06F 21/6209; G06F 21/6218

(57) ABSTRACT

Embodiments of the invention provide a method, system and computer program product for pattern driven data privacy management. A method for pattern driven data privacy management includes monitoring different attempts by one or more end users to access data in a database and a context in which each of the different attempts occur. The method additionally includes computing different patterns of access to the data according to different contexts in which the different attempts occur. Finally, the method includes responding to a contemporaneous attempt to access a portion of the data, by determining a contemporaneous context for the contemporaneous attempt, by comparing the contemporaneous context to a computed pattern of access for the portion of the data, and if the contemporaneous context deviates from a computed pattern of access for the portion of the data, by enforcing a data privacy rule in respect to the portion of the data.

### BACKGROUND OF THE INVENTION

1. Field of the Invention

The present invention relates to data privacy and more particularly to autonomic management of data privacy mechanisms.

2. Description of the Related Art

Data privacy is an aspect of information technology that addresses the need for an organization or individual to manage the extent of sharing access to data in a computer system. The extent of sharing access to data in a computer system can range from the creator of the data to unrelated, unknown third-parties to intermediate familiar parties there between. Most often, the extent of sharing access to data is related to the nature of the data itself. Data considered to be personal or to embody valuable secrets may enjoy a higher degree of data privacy, while data considered to be mundane, or well-known to the general public may enjoy a lesser degree of data privacy.

Traditionally, data privacy is an aspect of information technology managed in an ad hoc fashion by those controlling access to the data. In more sophisticated computing environments, data privacy is policy driven and sometimes enforced by programmatic rules. The latter instance oftentimes segregates different roles or classes of end users from one another, assigning different data privacy requirements for the different roles or classes. Typical data privacy requirements include the ability for an end user to view certain data, the nature of security measures required by an end user to access data, and the ability of the end user to transform the data into a different medium, such as by cut-copy-pasting the data, e-mailing the data, exporting the data or printing the data.

Irrespective of whether or not data privacy measures are implemented manually by the end user, or in an automated fashion, generally these measures are static and are imposed upon an end user strictly based upon the identity of the user and perhaps the association of the end user with a particular class of end users. Yet, the need for particular data privacy measures is not a static need. Rather, the need for particular data privacy measures is a dynamic need, changing based upon the nature of the data encountered and the context in which an end user attempts to access the data. Thus, oftentimes, an imposed data privacy measure may be overly burdensome, and other times an imposed data privacy measure may be sorely inadequate.

### BRIEF SUMMARY OF THE INVENTION

Embodiments of the present invention address deficiencies of the art in respect to pattern driven data privacy management and provide a novel and non-obvious method, system and computer program product for pattern driven data privacy management. In an embodiment of the invention, a method for pattern driven data privacy management is provided. The method includes monitoring different attempts by one or more end users to access data in a database and a context in which each of the different attempts occur. The method additionally includes computing different patterns of access to the data according to different contexts in which the different attempts occur. Finally, the method includes responding to a contemporaneous attempt to access a portion of the data, by determining a contemporaneous context for the contemporaneous attempt, by comparing the contemporaneous context to a computed pattern of access for the portion of the data, and if the contemporaneous context deviates from a computed pattern of access for the portion of the data, by enforcing a data privacy rule in respect to the portion of the data.

In one aspect of the embodiment, the attempts by the end users to access the data occur in respect to utilization by the end users of a corresponding application programmed to access the data in the database. In another aspect of the embodiment, the end users are classified according to role and the computed different patterns of access are computed with respect to each of the different roles. In yet another aspect of the embodiment, the contemporaneous context is a time of day during which an attempt to access the portion of the data occurs and wherein a corresponding computed one of the different patterns is a time of day during which attempts to access the portion of the data previously occurred. Alternatively, the contemporaneous context may be a geographical location at which an attempt to access the portion of the data occurs and wherein a corresponding computed one of the different patterns is a geographical location at which attempts to access the portion of the data previously occurred. In even yet another aspect of the embodiment, the privacy rule is to visually obscure the portion of the data or a rule to block access to the portion of the data.

In another embodiment of the invention, a data processing system is configured for pattern driven data privacy management. The system includes a host computing system that includes one or more computers, each with memory and at least one processor. The system also includes a database coupled to the host computing system and storing data in the database. The system yet further includes an application executing in the memory of the host computing system. The application including program code configured to request access to the data in the database in response to utilization by an end user of the application. Finally, the system includes a pattern driven data privacy management module.

The module includes program code enabled upon execution in the memory of the computer to monitor different attempts by the end user to access data in the database and a context in which each of the different attempts occur, to compute different patterns of access to the data according to different contexts in which the different attempts occur, and to respond to a contemporaneous attempt to access a portion of the data by determining a contemporaneous context for the contemporaneous attempt, by comparing the contemporaneous context to a computed pattern of access for the portion of the data, and if the contemporaneous context deviates from a computed pattern of access for the portion of the data, by enforcing a data privacy rule in respect to the portion of the data.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of a process for pattern driven data privacy management;

FIG. 2 is a schematic illustration of a data processing system configured for pattern driven data privacy management; and,

FIG. 3 is a flow chart illustrating a process for pattern driven data privacy management.

### DETAILED DESCRIPTION OF THE INVENTION

Embodiments of the invention provide for pattern driven data privacy management. In accordance with an embodiment of the invention, requests to access different portions of data in a data store can be monitored and associated with contexts in which the requests occurred. The contexts can include, by way of example, a time during which the requests occurred, or a geographic location from which the requests occurred, or a device or device type from which the requests occurred. The contexts to access the data can be analyzed in order to construct different patterns of access to different portions of the data. Thereafter, a data access request can be received for a portion of the data and a context for the received access request can be ascertained. A pattern previously established for the portion of data pertaining to the data access request can be retrieved and compared to the context for the received access request. To the extent that the context deviates from the pattern, one or more data privacy rules can be enforced on account of the deviation.

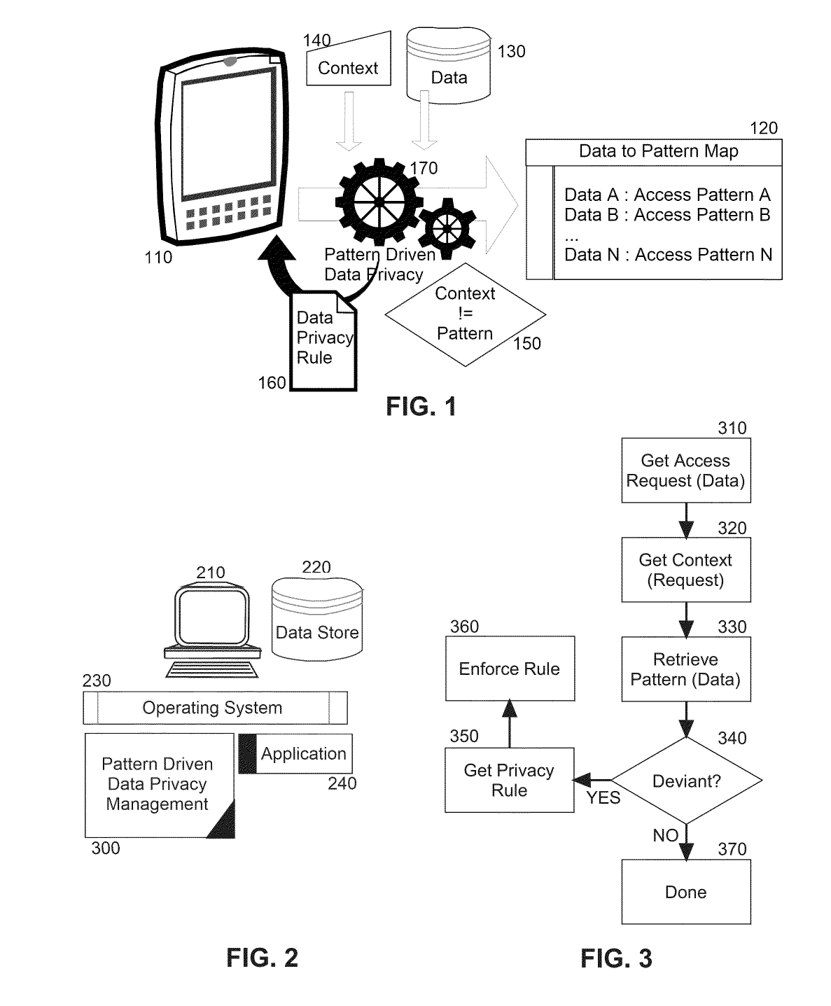

In further illustration, FIG. 1 pictorially illustrates a process for pattern driven data privacy management. As shown in FIG. 1, data requests for data in a data store 130 emanating from a computing device 110 can be monitored in order to generate a mapping 120 of portions of data requested to different contexts in which the requests occur. Pattern driven data privacy logic 170 thereafter can detect a data request for a portion of the data in the data store 130 and can determine a context 140 for the data request, such as a geographic location of the computing device 110 at the time of the request, or a time at which the request occurred. The pattern driven data privacy logic 170 then compares the context 140 to a pattern in the mapping 120 corresponding to the portion of data requested to detect a deviation 150. To the extent a deviation 150 is detected, the pattern driven data privacy logic 170 can direct the enforcement of at least one data privacy rule 160, such as obscuring elements of a display, or blocking access to the requested data.

The process described in connection with FIG. 1 can be implemented within a data processing system. In yet further illustration, FIG. 2 schematically shows a data processing system configured for pattern driven data privacy management. The system includes a host computing system 210 that includes one or more computers each with memory and at least one processor. The host computing system 210 can include a data store 220 storing data. An operating system 230 can execute in the memory of the host computing system 210 and can support the operation of one or more applications 240 (only a single application shown for the purpose of illustrative simplicity). In this regard, the application 240 can include operations accessing the data in the data store 220.

Of note, the operating system can host the operation of a pattern driven data privacy management module 300. The pattern driven data privacy management module 300 can include program code enabled upon execution in the memory of the host computing system 210 to respond to a detection of a data request for a portion of data in the data store 220 through application 240 by determining a context for the data request and retrieving a corresponding pattern for the portion of data. The program code of the module 300 can be further enabled to compare the determined context to the corresponding pattern. To the extent that the corresponding pattern differs from the context by a threshold amount, the program code of the module 300 can direct enforcement of one or more data privacy rules.

In even yet further illustration of the operation of the pattern driven data privacy management module 300, FIG. 3 is a flow chart illustrating a process for pattern driven data privacy management. Beginning in block 310 a data access request can be received for a portion of data in a data store as requested by an application. In block 320, a contemporaneous context can be determined for the data access request. In block 330, a pattern corresponding to the portion of the data can be retrieved from a pre-stored mapping and compared to the contemporaneous context. In decision block 340, if the comparison indicates a deviation from the pattern by the context, a privacy rule can be retrieved in block 350 and the rule enforced in block 360. Otherwise, the process can end in block 370.

The present invention may be embodied within a system, a method, a computer program product or any combination thereof. The computer program product may include a computer readable storage medium or media having computer readable program instructions thereon for causing a processor to carry out aspects of the present invention. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing.

A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Finally, the terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims as follows:

1. A method for pattern driven data privacy management, the method comprising:
monitoring different attempts by one or more end users to access data in a database and a context in which each of the different attempts occur;
computing different patterns of access to the data according to different contexts in which the different attempts occur;
mapping the computed different patterns to a respective portion of the data for which a mapped one of the patterns is computed; and,
responsive to a contemporaneous attempt to access a particular portion of the data, determining a contemporaneous context for the contemporaneous attempt, locating in the mapping a computed pattern for the particular portion of the data, comparing the contemporaneous context to the computed pattern of access for the particular portion of the data, and if the contemporaneous context deviates from a computed pattern of access for the particular portion of the data, enforcing a data privacy rule in respect to the particular portion of the data.

2. The method of claim 1, wherein the attempts by the one or more end users to access the data occur in respect to utilization by the one or more end users of a corresponding application programmed to access the data in the database.

3. The method of claim 1, wherein the one or more end users are classified according to role and the computed different patterns of access are computed with respect to each of different role of a corresponding one of the one or more end users.

4. The method of claim 1, wherein the contemporaneous context is a time of day during which an attempt to access the particular portion of the data occurs and wherein a corresponding computed one of the different patterns is a time of day during which attempts to access the particular portion of the data previously occurred.

5. The method of claim 1, wherein the contemporaneous context is a geographical location at which an attempt to access the particular portion of the data occurs and wherein a corresponding computed one of the different patterns is a geographical location at which attempts to access the particular portion of the data previously occurred.

6. The method of claim 1, wherein the privacy rule is to visually obscure the particular portion of the data.

7. The method of claim 1, wherein the privacy rule is to block access to the particular portion of the data.

8. A data processing system configured for pattern driven data privacy management, the system comprising:
a host computing system comprising one or more computers, each with memory and at least one processor;
a database coupled to the host computing system and storing data in the database;
an application executing in the memory of the host computing system, the application including program code configured to request access to the data in the database in response to utilization by an end user of the application; and,
a pattern driven data privacy management module comprising program code enabled upon execution in the memory of the computer to monitor different attempts by the end user to access data in the database and a context in which each of the different attempts occur, to compute different patterns of access to the data according to different contexts in which the different attempts occur, to map each of the computed different patterns to a respective portion of the data for which a mapped one of the patterns is computed, and to respond to a contemporaneous attempt to access a particular portion of the data by determining a contemporaneous context for the contemporaneous attempt, by locating in the map a computed pattern for the particular portion of the data, by comparing the contemporaneous context to the computed pattern of access for the particular portion of the data, and if the contemporaneous context deviates from a computed pattern of access for the particular portion of the data, by enforcing a data privacy rule in respect to the particular portion of the data.

9. The system of claim 8, wherein the contemporaneous context is a time of day during which an attempt to access the particular portion of the data occurs and wherein a corresponding computed one of the different patterns is a time of day during which attempts to access the particular portion of the data previously occurred.

10. The system of claim 8, wherein the contemporaneous context is a geographical location at which an attempt to access the particular portion of the data occurs and wherein a corresponding computed one of the different patterns is a geographical location at which attempts to access the particular portion of the data previously occurred.

11. The system of claim 8, wherein the privacy rule is to visually obscure the particular portion of the data.

12. The system of claim 8, wherein the privacy rule is to block access to the particular portion of the data.

13. A computer program product for pattern driven data privacy management, the computer program product comprising a non-transitory computer readable storage medium having program instructions embodied therewith, the program instructions executable by a device to cause the device to perform a method comprising:
monitoring different attempts by one or more end users to access data in a database and a context in which each of the different attempts occur;
computing different patterns of access to the data according to different contexts in which the different attempts occur;
mapping the computed different patterns to a respective portion of the data for which a mapped one of the patterns is computed; and,
responsive to a contemporaneous attempt to access a particular portion of the data, determining a contemporaneous context for the contemporaneous attempt, locating in the mapping a computed pattern for the particular portion of the data, comparing the contemporaneous context to the computed pattern of access for the particular portion of the data, and if the contemporaneous context deviates from a computed pattern of access for the particular portion of the data, enforcing a data privacy rule in respect to the particular portion of the data.

14. The computer program product of claim 13, wherein the attempts by the one or more end users to access the data occur in respect to utilization by the end users of a corresponding application programmed to access the data in the database.

15. The computer program product of claim 13, wherein the one or more end users are classified according to role and the computed different patterns of access are computed with respect to each of different role of a corresponding one of the one or more end users.

16. The computer program product of claim 13, wherein the contemporaneous context is a time of day during which an attempt to access the particular portion of the data occurs and wherein a corresponding computed one of the different patterns is a time of day during which attempts to access the particular portion of the data previously occurred.

17. The computer program product of claim 13, wherein the contemporaneous context is a geographical location at which an attempt to access the particular portion of the data occurs and wherein a corresponding computed one of the different patterns is a geographical location at which attempts to access the particular portion of the data previously occurred.

18. The computer program product of claim 13, wherein the privacy rule is to visually obscure the particular portion of the data.

19. The computer program product of claim 13, wherein the privacy rule is to block access to the particular portion of the data.

20. The computer program product of claim 13, wherein the contemporaneous context is a device identity from which an attempt to access the particular portion of the data occurs and wherein a corresponding computed one of the different patterns is a device identity from which attempts to access the particular portion of the data previously occurred.
